(19) United States
(12) Patent Application Publication
(10) Pub. No.: US 2016/0242440 A1
(43) Pub. Date: Aug. 25, 2016

(54) FOOD ADDITIVE COMPOSITION

(71) Applicant: Hilbert O. Northe, Hamilton (CA)

(72) Inventor: Hilbert O. Northe, Hamilton (CA)

(21) Appl. No.: 14/631,200

(22) Filed: Feb. 25, 2015

(51) Int. Cl. A23L 1/221

(52) U.S. Cl. CPC A23L 1/2212; A23V 2002/00

(57) ABSTRACT

The present concept is a food additive composition which is a food enhancer. The food additive composition includes Guyanese thyme, Italian thyme, garlic, onion, celery, parsley, spring onion, sea salt in several embodiments, optionally including sweet broom. The food additive composition can be supplied in the form of a paste, a liquid suspension and/or a dry powder. It can be added to food as it is cooking, used as a marinade, or may be used as a spice in powder form where it could replace salt, pepper, or other spices.

### FIELD OF THE INVENTION

The present concept relates generally to food supplements. The invention is an all in one food additive in the form of a paste, liquid suspension, or a powder.

### BACKGROUND OF THE INVENTION

The related art of interest describes various food additives and supplements but none discloses the present concept. There is need for a paste, liquid suspension or a powder food additive and/or marinade which supplies a variety of nutrients and flavours for enriching the flavour in one's food.

U.S. Pat. No. 7,510,738 titled Flavour Enhancing Food Additive by Daniel M. Goral issued Mar. 31, 2009 describes a flavour enhancing product that consists essentially of fish sauce blended with anchovy paste.

U.S. Pat. No. 5,232,732 titled Dry Soup Mix filed by inventor Norma E. Harris issued Aug. 3, 1993 describes a dry soup mix adapted to be combined with water and residual food items in field ration tray packs.

U.S. Pat. No. 6,558,691 titled Food Additive Composition filed by inventor Teddy A. Koumarianos issued May 6, 2003 describes a food additive composition in a ground particulate composition containing multiple vitamins, calcium citrate, sugar, minerals and herbs.

### SUMMARY OF THE INVENTION

The present invention is a food additive composition which is a food enhancer which can be supplied in the form of a paste, a liquid suspension and/or a dry powder. The food additive composition can be added to food being cooked included in appetizers, it may be sprinkled on any food, or it may be used as a marinade. As a food marinade it is preferably in the form of paste or a liquid suspension in which case the food that is to be prepared such as beef, chicken, fish can be rubbed with the paste or the liquid suspension and placed in a container in the refrigerator for marinating from between 4 and 48 hours.

This food additive composition can also be used as a spice in powder form in which case it would be intended to replace salt, pepper and other spices.

### DETAILED DESCRIPTION OF THE PREFERRED EMBODIMENT

The present concept a food additive composition can be prepared in the form of a paste, a liquid suspension and/or a powder. The food additive composition can be used as a marinade for example for marinating beef, chicken and/or fish by rubbing the paste and/or liquid suspension onto the surface of the meat and allowing it to sit in a refrigerator for between 4 and 48 hours prior to cooking.

In the form of a powder the current food additive composition can be used in the place of a spice in which case the food additive composition is sprinkled onto the food prior to eating similarly as salt, pepper and other spices are now currently added to foods.

The main composition is summarized in Table 1 below which gives both a range for each of the ingredients as well as the preferred amount.

Optionally as shown in Table 1 Sweet Broom can also be added in the amounts of 5% to 10% by weight and preferably in the amount of 10% to add further flavouring.

### BEST MODE FOR CARRYING OUT THE INVENTION

TABLE 1

| | Range | |
|---|---|---|
| | Preferred Amount | Binomial Name & Common |
| Ingredient | Percentage by weight | Name Synonyms |
| Guyanese Thyme | 35-55 | Plectranthus Amboinicus |
| | 45 | Spanish Thyme (US) |
| | | Thick Leaf Thyme (Guyana) |
| | | Broad Leaf Thyme (Barbados) |
| Italian Thyme | 5-15 | Thymus Vulgaris |
| | 10 | Common thyme (usa) |
| Garlic | 5-15 | Allium Sativum |
| | 10 | |
| Onion | 5-15 | Allium Cepa |
| | 10 | |
| Celery | 5-15 | Apium Dulce |
| | 10 | |
| Parsley | 5-15 | Petroselinum Crispum |
| | 10 | Garden Parsley |
| Spring Onion | 5-15 | Allium Cepa |
| | 5 | Scallion, Green onion |
| Sea Salt | 0.1-0.5 | salt |
| Optional Added | | |
| Sweet Broom | 5-15 | Genista Stenopetala |
| | 10 | Easter Broom |

The art as listed above are preferably pureed in a blender until they form a paste and/or liquid suspension. Depending upon the amount of moisture in the various herbs that are used in the food additive composition the final result may be a fairly thick paste and/or a slightly more liquid suspension. It is possible to add water to the food additive composition if desired to further liquefy the paste thereby creating a more free flowing liquid suspension.

In one form the pureed ingredients which normally form a paste can be dried to form a powder. The powder may be ground to any particle size desired for example such as salt & pepper.

As indicated above the food additive composition in paste form is preferably used as a marinade wherein the pureed mixture is applied to the surface of beef, poultry and/or fish and preferably placed into an airtight container and allowed to marinate from between 4 and 48 hours in a refrigerated environment.

The food additive composition in the form of a dry powder can be used as a food additive in similar fashion as salt and pepper and other spices which are currently used on foods by simply sprinkling it onto the surface of the foods being prepared or by mixing into foods which are liquid in nature such as stews and soups.

It should be apparent to persons skilled in the arts that various modifications and adaptation of this structure described above are possible without departure from the spirit of the invention the scope of which defined in the appended claim.

I claim:

1. A food additive composition comprising:
a) 35 to 55% by weight Guyanese thyme;
b) 5 to 15% by weight Italian thyme
c) 5 to 15% by weight garlic
d) 5 to 15% by weight onion
e) 5 to 15% by weight celery
f) 5 to 15% by weight parsley
g) 5 to 15% by weight spring onion
h) 0.1 to 0.5% by weight sea salt

2. A food additive composition claimed in claim 1 wherein the composition comprises:
a) 44.5% by weight Guyanese thyme;
b) 10% by weight Italian thyme;
c) 10% by weight garlic;
d) 10% by weight onion;
e) 10% by weight celery;
f) 10% by weight parsley;
g) 5% by weight spring onion;
h) 0.5% by weight sea salt.

3. A food additive composition claimed in claim 1 further comprising:
i) 5 to 15% by weight sweet broom

4. A food additive composition claimed in claim 3 wherein the composition comprises:
a) 44.5% by weight Guyanese thyme;
b) 9% by weight Italian thyme;
c) 9% by weight garlic;
d) 9% by weight onion;
e) 9% by weight celery;
f) 9% by weight parsley;
g) 4% by weight spring onion;
h) 0.5% by weight sea salt.
i) 6% by weight sweet broom

5. A food marinate composition comprising:
a) 35 to 55% by weight Guyanese thyme;
b) 5 to 15% by weight Italian thyme
c) 5 to 15% by weight garlic
d) 5 to 15% by weight onion
e) 5 to 15% by weight celery
f) 5 to 15% by weight parsley
g) 5 to 15% by weight spring onion
h) 0.1 to 0.5% by weight sea salt

6. A food marinate composition claimed in claim 5 wherein the composition comprises:
j) 44.5% by weight Guyanese thyme;
k) 10% by weight Italian thyme;
l) 10% by weight garlic;
m) 10% by weight onion;
n) 10% by weight celery;
o) 10% by weight parsley;
p) 5% by weight spring onion;
q) 0.5% by weight sea salt.

7. A food additive composition claimed in claim 5 further comprising:
r) 5 to 15% by weight sweet broom

8. A food additive composition claimed in claim 7 wherein the composition comprises:
j) 44.5% by weight Guyanese thyme;
k) 9% by weight Italian thyme;
l) 9% by weight garlic;
m) 9% by weight onion;
n) 9% by weight celery;
o) 9% by weight parsley;
p) 4% by weight spring onion;
q) 0.5% by weight sea salt.
r) 6% by weight sweet broom
